(19) United States
(12) Patent Application Publication
(10) Pub. No.: US 2022/0397319 A1
(43) Pub. Date: Dec. 15, 2022

(54) EXPANSION DEVICE FOR REFRIGERATION APPARATUSES

(71) Applicant: Hydro Extrusion Brasil S.A., Itu (BR)

(72) Inventor: Elton Ferreira Higino de CUBA, Sorocaba (BR)

(21) Appl. No.: 17/633,862

(22) PCT Filed: Aug. 9, 2019
(86) PCT No.: PCT/BR2019/050326

§ 371 Date: Feb. 8, 2022

(51) Int. Cl. F25B 41/37

(52) U.S. Cl. CPC F25B 41/37; F25B 2500/05

(57) ABSTRACT

The invention relates to an expansion device for refrigeration apparatuses, comprising a suction tube (1) and a capillary tube (2) in a single extruded aluminum profile, in which the two parallel tubes, referred to as the suction tube (1) and the capillary tube (2), are linked together by a wall portion in the manner of a connection (3), in which said connection-shaped wall (3) can thus be cut to a sufficient desired length to release the ends of the suction tube (1) and of the capillary tube (2) at both tips or just one tip of the device, logically so that said tips can be handled and adapted to suit each project.

### CROSS-REFERENCE TO RELATED APPLICATIONS

This application is a national phase entry of International Application No. PCT/BR2019/050326, filed Aug. 9, 2019, the disclosure of which is incorporated by reference herein.

### TECHNICAL FIELD

The present disclosure relates to improving heat transfer in commercial freezers, home freezers and refrigerators. More particularly, the present disclosure relates to technical, functional, and economic improvements applied to a particular type of expansion device traditionally used in different refrigeration systems, such as: refrigerators in general, freezers, refrigerated displays, refrigerated counters, air conditioners and others.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

In traditional refrigeration systems, an expansion device may be installed between a condenser outlet and an evaporator inlet. The refrigerant, with high pressure and temperature, may come from the condenser and may enter the expansion device and exit therefrom with a mixture of liquid and vapor with low pressure and low temperature. This mixture, which enters into the evaporator, is known as “flash gas.” Regardless of the type, an expansion device may be used to carry out at least two functions in the refrigeration cycle: to allow the liquid refrigerant to enter the evaporator at a flow rate compatible with the speed at which it evaporates; and to provide a pressure and temperature drop, separating the high pressure side from the low pressure side of the system.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In an embodiment, the disclosure describes an expansion device for refrigeration apparatuses. The expansion device may include a suction tube, capillary tube parallel to the suction tube; and a connection wall linking the suction tube and the capillary tube together. The suction tube, the capillary tube, and the connection may be formed by a single extruded aluminum profile.

### BRIEF DESCRIPTION OF THE DRAWINGS

The disclosure may be better understood by references to the detailed description when considered in connection with the accompanying drawings. The components in the figures are not necessarily to scale, emphasis instead being placed upon illustrating the principles of the disclosure. In the figures, like reference numerals designate corresponding parts throughout the different views.

For a better understanding of the present invention, there follows a detailed description thereof with reference to the attached drawings:

FIG. 1 represents a perspective view showing an embodiment of an expansion device as shown and described herein;

FIG. 2 shows an enlarged cross-sectional view of the expansion device of FIG. 1, emphasizing the single profile of the expansion device;

FIG. 3 illustrates another cross-sectional view of the expansion device of FIG. 1 highlighting the connection wall between the two tubes; and

FIG. 4 is a perspective view of another embodiment of an expansion device as shown and described herein, wherein the ends of the two tubes can be partially separated.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION

The present invention now will be described more fully hereinafter with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

In some embodiments of refrigeration systems, the difference in pressure between high and low sides of an expansion device may cause refrigerant to evaporate in an evaporator at a temperature that is sufficiently low to absorb the heat of the environment and for it to condense in the condenser at a temperature that is sufficiently high to remove the indoor heat to the outdoor air. In some embodiments, the time for the heat to be exchanged between the refrigerant in the expansion device and the outdoor air which surrounds it is so short that it may be ignored for practical purposes. For this reason, the expansion device may operate as just a pressure drop device, where the change in temperature of the refrigerant may substantially solely be the result of the pressure drop. Since there is no heat rejection in the expansion device, only temperature drop, in such embodiments, part of the sensible heat transforms into latent heat.

In some embodiments, two basic types of expansion devices may be used in refrigeration systems: capillary tube and valves, these can be automatic, of thermostatic expansion and of electronic expansion.

The capillary tube may be a tube having a small inner diameter which may usually be used in refrigeration systems to separate the high pressure line from the low pressure one. The capillary tube may be a heat exchanger since it may be coiled around the suction tube, exchanging heat with it. The capillary tube may be made of copper and may be common in small capacity cooling systems: refrigerators, air conditioners, freezers, and others. The capillary tube may connect the condenser outlet with the evaporator inlet. In some embodiments, the inner diameter of the capillary tube may vary from 0.5 to 2.5 mm, and the length from 1.5 to 3.5 m, whereby at least 1.2 m of this total of the capillary tube may be soldered at the aspiration line to obtain cooling via the cold vapors from the evaporator.

Therefore, in some embodiments, the suction line which may constitute the expansion device may be defined by a copper or aluminum suction tube plus copper capillary tube, both separated from each other, however, they may also be assembled using steps, such as: a copper capillary tube coil and another tube coil for the suction line are received; both the capillary tube and the suction line may be cut at the desired length; the capillary tube may be assembled at the suction line, helping ensure a thermal exchange area between both of them; a tape may be used to ensure the thermal exchange area between capillary tube and suction line; and the suction line plus capillary may have bends so that they remain in the configuration specified particular to each project.

Therefore, the coupling between the suction line and the capillary tube may be used by the HVAC (heating, ventilation, and air conditioner) market segments of white products. In some embodiments, the basic principle may involve cooling the refrigerant at the capillary tube to reduce the enthalpy at the evaporator inlet and then improving the heat transfer. On the other hand, the refrigerant at the suction line may heat up to avoid the refrigerant in liquid phase entering the compressor, which may lead to valve plate breakage.

In some embodiments, some coupling solutions of the suction line and capillary tubes may include: (a) thermal retraction sleeve and adhesive tape; (b) coupling using the insertion of the capillary tube inside the tube of the suction line; (c) capillary tube brazing along the suction line.

In (a) and (b), the suction line can be made of aluminum or copper, and the capillary tube may be made of aluminum. In (c), both the suction line as the capillary tube may be made of copper. The solution (c) may be considered the more efficient because the refrigerant changes from liquid phase to vapor, and then the heat is transferred by the conductivity through the tube wall. In solution (b) there is no guarantee that the capillary tube will be concluded emerged in the liquid phase of the refrigerant and in (a) there may be poor contact between capillary tube and suction line.

This disclosure describes, in some embodiments, a more efficient product, following the concept (c) described above, combined with a reduction in costs mainly in the replacement of the copper capillary tube with the aluminum capillary tube of the integrated extrusion solution. Said solution may be reached with the disclosed single piece expansion device, wherein the line or suction tube and the capillary tube may be extruded in aluminum as a single profile, consequently, the expansion device may include two parallel tubes interconnected by a continuous wall portion called a bond, forming a single aluminum set, wherein the details of the connection between the two pieces may be already integrated to the set and, further, may include eliminating additional assembly components which also may concur to increase the thermal exchange between the two tubes, concluding in a set for different cooling applications which may use as an expansion device a capillary tube, whether they are commercial or for households, such as: refrigerators, freezers, displays, refrigerated counters, air conditioners and others.

The disclosed expansion device may present different technical, practical and economic advantages, since it is initially observed that the cost of the aluminum is significantly lower than the cost of copper and, moreover, the density thereof corresponds to 30% of that of copper, respectively, 2.70 g/cm3 and 8.90 g/cm3. This may mean a solution having less weight. Since the capillary tube may be extruded jointly with the tube (suction line), a heat exchange area may be ensured in advance between capillary tube and suction line, which may reduce or eliminate the need for tape or brazing. Additionally, the number of items for stock programming/planning on the client side may be reduced from 2 items (suction line tube and capillary tube) to 1 item. There may be an expectation of improvement in the heat exchange, since the set comes down to a single piece.

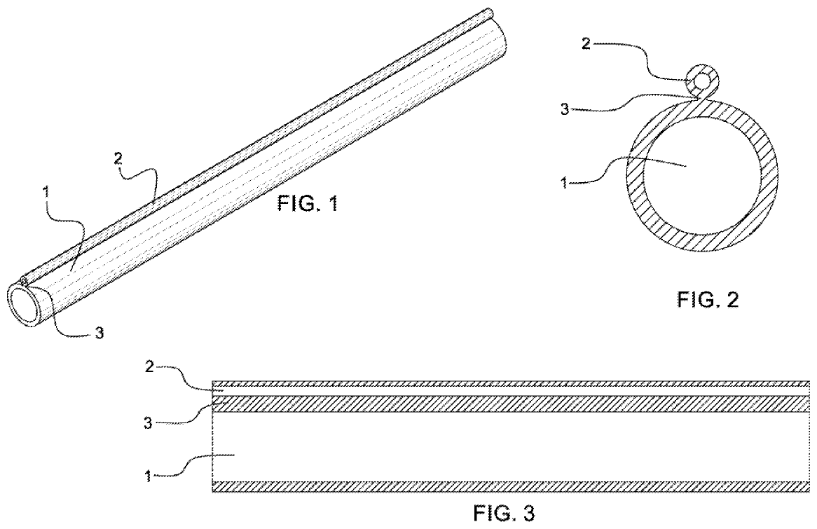

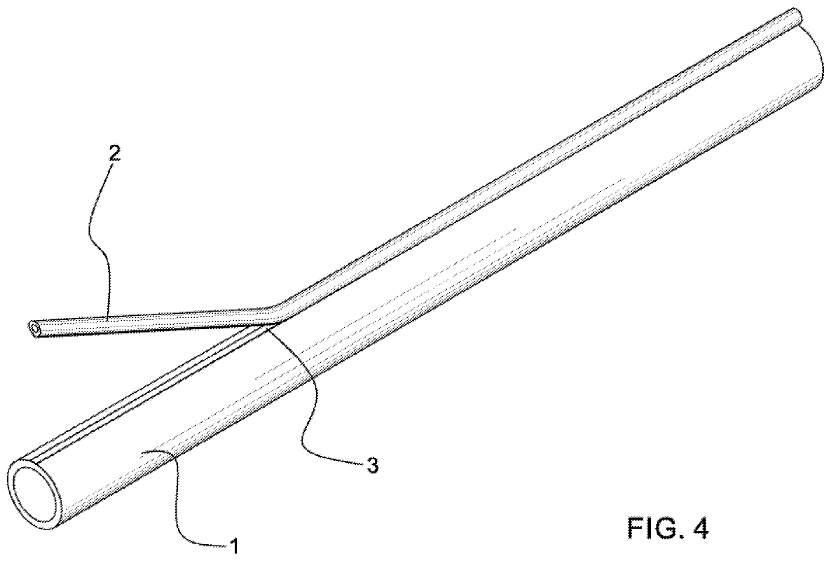

Referring now to tif figures, more particularly FIGS. 1, 2 and 3, the present disclosure comprises, in some embodiments, a suction tube (1) and a capillary tube (2), which may be formed by a single extruded aluminum profile, wherein the two parallel tubes, referred to as the suction tube (1) and capillary tube (2), may be interconnected by a connection-shaped wall portion (3).

As illustrated in FIG. 4, said connection-shaped wall (3) may be of the type which may be cut to a sufficient desired length to release the ends of the suction tube (1) and of the capillary tube (2) at both tips or just one tip of the device, logically so that said tips may be handled and adapted to suit each project.

The set may be defined, in some embodiments, as a single piece, consequently, the suction line plus the capillary can have different bends and curves, not only at those separate tips, but also along the whole piece, providing means for each set to have a specified configuration for each project.

In some embodiments, the operation of the set may be the same as that of traditional expansion devices, that is, the refrigerant fluid may continue flowing through the suction tube (1) and the capillary tube (2), that is, the refrigerant, with high pressure and temperature, may come from the condenser and may enter the expansion device and exit therefrom with a mixture of liquid and vapor having low pressure and low temperature. This mixture that enters into the evaporator may be known as “flash gas.” Regardless of the type, the expansion device may be used to carry out two important functions in the refrigeration cycle: to allow the liquid refrigerant to enter the evaporator at a flow rate compatible with the speed at which it evaporates; and to provide a pressure and temperature drop, separating the high pressure side from the low pressure side of the system. In some embodiments, this difference in pressure between the high and low sides makes the refrigerant to evaporate in the evaporator at a temperature that may be sufficiently low to absorb the heat of the environment and for it to condense in the condenser at a temperature that is sufficiently high to remove the indoor heat to the outdoor air.

It will be understood that certain characteristics and combinations of the disclosure, in relation to the suction tube and the capillary tube, may vary considerably while maintaining the same functional concept for the set. Consequently, it should be noted that the embodiment described in detail herein as an example is clearly subject to constructive variations, however, within the scope of the disclosure to define an expansion device in a single piece, wherein the suction line or tube and the capillary tube may be extruded in aluminum as a single profile, and since many alterations can be made in the configuration now detailed according to the requirements prescribed by law, it is understood that the present details must be interpreted in an illustrative rather than limiting manner.

In other words, the figures depict preferred embodiments for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. An expansion device for refrigeration apparatuses, the expansion device comprising:
a suction tube;
a capillary tube parallel to the suction tube; and
a connection wall linking the suction tube and the capillary tube together, wherein the suction tube, the capillary tube, and the connection are formed by a single extruded aluminum profile.

2. The expansion device of claim 1, wherein the connection wall is configured to be cut to a sufficient length to release ends of the suction tube and of the capillary tube at one or more tips of the expansion device.
